(19) United States
(12) Patent Application Publication
(10) Pub. No.: US 2021/0348670 A1
(43) Pub. Date: Nov. 11, 2021

(54) Safety Luggage Strap with Anti-scratch Hook Head

(71) Applicant: Tonglu Huabang Hardware Tools Co., Ltd., Hangzhou, Zhejiang Province (CN)

(72) Inventor: Zhenghua CHU, Hangzhou, Zhejiang Province (CN)

(73) Assignee: Tonglu Huabang Hardware Tools Co., Ltd., Hangzhou, Zhejiang Province (CN)

(21) Appl. No.: 16/463,319

(22) PCT Filed: Jan. 28, 2019
(86) PCT No.: PCT/CN2019/073457

§ 371 Date: May 22, 2019

(30) Foreign Application Priority Data
Dec. 21, 2018 (CN) 201822156304.3

(51) Int. Cl. F16G 11/14; B60P 7/08

(52) U.S. Cl. CPC F16G 11/143; B60P 7/0823

(57) ABSTRACT

The utility model discloses a safety luggage strap with an anti-scratch hook head, which mainly comprises a hook, a tensioning hoop and a telescopic rope, wherein each of rope heads at both ends of the telescopic rope passes through a bent portion of one hook, and the rope heads at the both ends of the telescopic rope are reversed itself and then tightly hooped by the tensioning hoops to prevent the rope heads from being retracted from the inside of the bent portions, thereby enabling the connection between the hooks and the telescopic rope. The head of the hook is a spherical hook head which is a smooth spherical body. The spherical hook head is bent toward an inner side of the hook.

### FIELD OF THE INVENTION

The utility model relates to the field of luggage straps, and particularly to a safety luggage strap with an anti-scratch hook head.

### BACKGROUND OF THE INVENTION

An existing luggage strap with a hook head prevents scratching articles and users' limbs by adding a plastic or rubber protective sleeve to its hook head, but plastic and rubber protective sleeves are prone to aging, breakage and fall-off after use for a long time, and hence fail to provide a protective effect; and the existing protection method has the defects of high production cost and troublesome assembly.

### SUMMARY OF THE INVENTION

An object of the utility model is to provide a safety luggage strap with an anti-scratch hook head so as to overcome the disadvantages of the prior art.

The object of the utility model is achieved by the following technical solution: the safety luggage strap with an anti-scratch hook head mainly comprises a hook, a bent portion, a rope head, a tensioning hoop and a telescopic rope, wherein each of the rope heads at both ends of the telescopic rope passes through the bent portion of one hook, and the rope heads at the both ends of the telescopic rope are reversed itself and then tightly hooped by the tensioning hoops to prevent the rope heads from being retracted from the inside of the bent portions, thereby enabling the connection between the hooks and the telescopic rope. The head of the hook is a spherical hook head which is a smooth spherical body The spherical hook head is bent toward an inner side of the hook, which protects the human body and articles more effectively.

The bent portion is a spring-type multi-layer spiral structure.

The utility model has the following beneficial effects: the utility model relates to a safety luggage strap tool with an anti-scratch hook head, which is capable of fastening a plurality of articles together, wherein the designed spherical hook head avoids scratching articles and users' limbs when hooking the articles, which effectively prevents the rebounding of the hook after hands are removed, thus avoiding scratching and injuring the human body by the hook head; and the safety luggage strap tool prevents scratching by changing its shape, which avoids the disadvantages of aging, breakage and fall-off of traditional plastic and rubber protective sleeves, thereby greatly saving the production cost.

### BRIEF DESCRIPTION OF THE DRAWINGS

FIG. 1 is a schematic structural view of the utility model; and

FIG. 2 is a schematic structural view of a hook of the utility model.

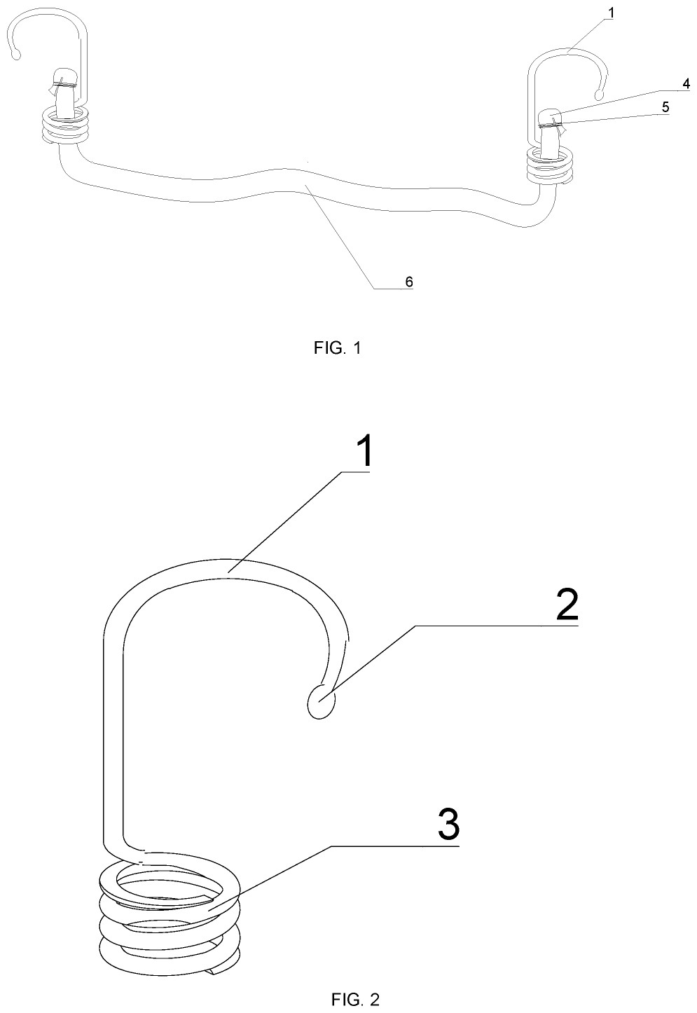

Description of reference numerals: hook 1; spherical hook head 2; bent portion 3; rope head 4; tensioning hoop 5; telescopic rope 6; hook plastic sleeve 7.

### DETAILED DESCRIPTION OF THE INVENTION

The utility model will be described below in detail with reference to the drawings.

Embodiment: as shown in the Figures, the safety luggage strap with an anti-scratch hook head mainly comprises a hook 1, a bent portion 3, a rope head 4, a tensioning hoop 5 and a telescopic rope 6, wherein each of the rope heads 4 at both ends of the telescopic rope 6 passes through the bent portion 3 of one hook 1, and the bent portion 3 is a spring-type multi-layer spiral structure which is firm and not easy to fall off. The rope heads 4 at the both ends of the telescopic rope 6 are reversed itself and then tightly hooped by the tensioning hoops 5 to prevent the rope heads 4 from being retracted from the inside of the bent portions 3, thereby enabling the connection between the hooks 1 and the telescopic rope 6. The head of the hook 1 is a spherical hook head 2 which is a smooth spherical body that does not scratch other articles and the skin. Moreover, the spherical hook head 2 is concave toward an inner side of the hook 1, which protects the human body and articles more effectively.

It should be understood that, for those skilled in the art, the equivalent replacements or changes of the technical solutions and the concept of the utility model should fall within the protection scope of the appended claims of the utility model.

1. A safety luggage strap with an anti-scratch hook head, mainly comprising a hook, a bent portion, a rope head, a tensioning hoop and a telescopic rope, wherein each of the rope heads at both ends of the telescopic rope passes through the bent portion of one hook, and the rope heads at the both ends of the telescopic rope are reversed itself and then tightly hooped by the tensioning hoops to prevent the rope heads from being retracted from the inside of the bent portions; and the head of the hook is a spherical hook head which is a smooth spherical body, and the spherical hook head is bent toward an inner side of the hook.

2. The safety luggage strap with an anti-scratch hook head according to claim 1, wherein the bent portion is a spring-type multi-layer spiral structure.
